(19) United States
(12) Patent Application Publication
(10) Pub. No.: US 2025/0012673 A1
(43) Pub. Date: Jan. 9, 2025

(54) Test Stand and Method for Protecting Driver Assistance Systems of Automated Motor Vehicles

(71) Applicant: Bayerische Motoren Werke Aktiengesellschaft, Muenchen (DE)

(72) Inventors: Martin HELLER, Graben (DE); Till KOST, White Plains, NY (US)

(21) Appl. No.: 18/711,673

(22) PCT Filed: Jan. 17, 2023
(86) PCT No.: PCT/EP2023/050979

§ 371 Date: May 20, 2024

(30) Foreign Application Priority Data
Jan. 28, 2022 (DE) 10 2022 102 068.1

(51) Int. Cl. G01M 17/007

(52) U.S. Cl. CPC G01M 17/007

(57) ABSTRACT

A test stand for protecting driver assistance systems of automated motor vehicles includes a rail system having at least two guide rails which intersect at an intersection point, each guide rail having a transport carriage for transporting a test vehicle, and a safety system having a priority circuit which is arranged at the intersection point. The safety system is designed to prevent the intersection point being passed through simultaneously by the two transport carriages.

### BACKGROUND AND SUMMARY

The present invention relates to a test stand for the protection of driver assistance systems of automated motor vehicles and a method for operating such a test stand.

For the protection of driver assistance systems, target models are traditionally used. These can be moved by carrier platforms suspended, rolling or sliding according to the objective. The weight of these targets is optimized for the application and the targets are usually mostly foam. Due to their low weight compared to real vehicles, it is also easier to move the targets. Changes in approval regulations and changed requirements for the protection of driver assistance systems, especially with regard to the speeds of the targets and the diversity of the targets, make it necessary to use real vehicles for validation. For safety reasons, it is sometimes necessary to move the real vehicles rail-guided without a driver. More precisely, it is sometimes necessary to, for example, determine the capture angle of a camera and/or radar system to simulate predefined scenarios in which a trajectory of the motor vehicle to be tested and a trajectory of the target intersect at different angles. This means that at least two vehicles can drive offset from each other, but towards each other. One of the challenges here is to design a rail system in such a way that a collision of the test vehicles at an intersection point of two rails of the rail system can be prevented with sufficient safety. In this way, damage to the test stand and the test vehicles can be avoided.

Against the background of this prior art, the object of the present invention is to provide an apparatus and a method which are each suitable at least for overcoming the aforementioned disadvantages of the prior art.

The object is achieved by the characteristics of the independent claims. The dependent claims contain preferred development of the invention.

Accordingly, the object is achieved by a test stand for protecting the driver assistance systems of automated motor vehicles.

The test stand contains a rail system with at least two guide rails intersecting at an intersection point, a transport carriage for each guide rail for transporting a test vehicle, and a safety system having a priority circuit arranged at the intersection point, which is designed to prevent the two transport carriages from passing through the intersection point at the same time.

In other words, the disclosure is based on the principle of a rail guide for transport carriages which, during a test on the test stand, preferably absorb shear forces transmitted by means of the transport carriage as well as vertical tensile forces, but also preferably provide sufficiently precise acceleration, speed and deceleration as well as position detection of the transport carriage. In this case, according to the disclosure, an intersection element or intersection point is provided, at which the two guide rails cross or meet, for example at an optionally changeable angle of 0° or 45° (or an angle between 45° and 900). Here, approaches from different angles to a possible collision point, i.e. the intersection point, can be simulated. Depending on the direction of acceleration of the respective test vehicles fixed on the transport carriage used, left-hand traffic, right-hand traffic and approach from a predetermined angle, for example in 45° increments, can be achieved. In principle, the offset of the test vehicles can be used to vary a capture angle for a sensor system to be tested in one of the test vehicles. For this purpose, different speeds can be implemented, which lead to the systems being moved to the collision area at the intersection point with a high criticality. Therefore, in order to prevent a collision at the intersection point, the priority circuit is provided, which prevents a collision of two vehicles moving towards the intersection point at the same time and attached to the respective transport carriage.

Developments of the test stand described above are described in detail below.

The rail system may include a motor per guide rail for moving the respective transport carriage along the guide rail and a first position sensor system arranged along the guide rails, which is designed to capture a respective current first actual position of the transport carriages. In addition, the rail system may contain a control unit for the rail system, which is designed to control a target position and target speed of the respective transport carriage by means of the respective motor based on the first actual positions captured by the first position sensor system in such a way that the transport carriages pass through the intersection point without being at the intersection point at the same time.

For example, the motor can be a linear motor or linear drive. This means that for each of the at least two guide rails, a drive device is provided which is designed to move the transport carriage along the respective guide rail as a driven object, in particular in a straight line. In such a linear motor guided system, overcoming the intersection point by interrupting the power supply can be solved in such a way that the respective transport carriage on the respective sections of the respective guide rail can be supplied with energy separately. In this way, it can be ensured that a driving force can be provided by means of the motor both on the exited section and on the section after the intersection point.

The first position sensor system may essentially be installed and/or arranged along the entire length of the respective guide rail to capture a current actual position of the respective transport carriage along essentially the entire length of the respective guide rail.

The control unit for the rail system may have an input interface via which the control unit for the rail system is connected to the first position sensor system, optionally wirelessly and/or wired, and via which the control unit for the rail system receives the current actual positions of the transport carriages captured by the first position sensor system. The control unit may have a computing unit designed to generate a control signal to be output to the motors using an algorithm that uses the current actual positions as input data. The algorithm can be stored in a memory of the control unit and/or can be storable, especially in a changeable way. The computing unit can be connected to an output interface via which the control signal is output to the respective motors of the guide rails. Based on the control signal, the motors can influence the movement of the transport carriages in terms of the position and speed thereof.

The safety system may have a control unit for the priority circuit and a second position sensor system located in the area of the intersection point, which is designed to determine a respective second actual position of the transport carriages. The control unit for the priority circuit may be designed to control the priority circuit based on the second actual positions captured by the second position sensor system in such a way that the priority circuit prevents the transport carriages from passing through the intersection point at the same time.

The second position sensor system can essentially only capture the actual positions of the transport carriages in the area of the intersection point, i.e. just before and just after the intersection point. In particular, this can be a discontinuous determination of the current actual positions, i.e. it can be determined whether the respective transport carriage has entered the area at the intersection point and, if so, whether the respective transport carriage has left the area at the intersection point again. This can be done, for example, by means of light barriers, which are arranged before and after the intersection point.

The control unit for the priority circuit may have an input interface via which the control unit for the priority circuit is connected to the second position sensor system, optionally wirelessly and/or wired, and via which the control unit for the priority circuit receives the current actual positions of the transport carriages captured by the second position sensor system. The control unit may have a computing unit which is designed to calculate a control signal to be output to the priority circuit using an algorithm that uses the current second actual positions as input data. The algorithm can be stored in a memory of the control unit and/or is able to be stored, especially in a changeable way. The computing unit can be connected to an output interface via which the control signal is output to the priority circuit. Based on the control signal, the priority circuit can pass through the respective transport carriage, in particular unhindered, and/or can decelerate it, in particular can stop it.

The control unit for the priority circuit can be designed to control the priority circuit based on the second actual position data in such a way that driving over the intersection point can be prevented for a second of the two transport carriages for a predetermined period of time after a first of the two transport carriages reaches the area of the intersection point.

It is conceivable that the length or duration of the predetermined period depends on the speed of the two transport carriages.

The control unit for the priority circuit and the control unit for the rail system may be implemented as two separate systems, in particular physically separate. That is, redundant protection can be provided whereby in the event of a failure of one of the two systems, i.e. the system controlled by the control unit for the priority circuit or the system controlled by the control unit for the rail system, a collision of the transport carriages at the intersection point can also be avoided.

The priority circuit may have at least one brake system with two brake actuators with brake shoes arranged opposite each other on the guide rail in the area of the intersection point for each guide rail for braking or stopping the respective transport carriage.

Preferably, the priority circuit has two of the brake systems for each guide rail, wherein a first of the two brake systems is arranged on one side of the intersection point and a second of the two brake systems is arranged on the opposite side of the intersection point, so that the respective guide rail can be operated in both directions or bidirectionally.

The brake shoes of the brake system may be movable towards and/or away from each other by means of the brake actuators in order to reduce and/or increase the passable width of the guide rail in question for the respective transport carriage.

It is contemplated that, in an initial position, the brake shoes prevent the transport carriages from passing through and, when the safety system is activated, are actively moved apart in order to open up a passable path in the respective guide rail for the respective transport carriage. Preferably, a mechanical reset is carried out automatically once the safety system is deactivated. This means that even in the event of an electrical or electromechanical failure of the rest of the safety system, a locking position of the brake shoes can be automatically achieved, thus preventing a collision at the intersection point. In other words, the brake systems, which may be implemented as electromechanical brake actuators, can be preloaded in such a way that in their normal or standard position the brake systems can initiate the braking of the transport carriages and a safety computer must actively release this braking device during normal operation. In the event of a system failure, the system can brake in all directions for safety reasons.

The brake shoes of the brake system may have a shape that widens towards the intersection point, in particular linearly. This means that the brake shoes can be wedge-shaped or triangular in a top view. The braking device can be oriented in such a way that the maximum deceleration occurs and is reinforced by a wedge shape of the brake elements. The brake elements can be wider in the direction of travel of the transport carriages and can therefore brake by means of wedging. As a result, the transport carriage can initially be subjected to a low braking force, but this increases in the course of braking, so that at no time in the braking of the transport carriage is a limit value of a maximum (negative) acceleration of the system exceeded.

The arrangement described above can be summarized in different words and in relation to a more specific implementation of the disclosure as set out below.

If two carriages are used on the respective rail equipment, it can be ensured that a collision at the intersection point is avoided. According to the disclosure, an electromechanical or mechanical braking device may be installed in all rail systems before the common intersection point. These can be controlled by means of a locking arrangement and a priority circuit, which can ensure safe collision avoidance of crossing carriages independently of the basic collision-preventing control of the system.

The system can be electromechanical, but also optionally purely mechanical. By means of a control computer, position sensors and mechanical brakes in the rail system, safe deceleration of the carriages can be ensured for collision avoidance.

When driving across the significant safety points in the rail system (so-called. second position sensor system), crossing the intersection point by the second vehicle transport carriage can be temporarily excluded by the mechanical brake in the rail system due to the first vehicle transport carriage reaching the intersections. After a successful crossing by the priority transport carriage, this protection system can be released again.

The control of the target movement, i.e. of the vehicle transport carriages, can be designed in such a way that a collision is generally avoided. The safety system can override this system and prevent a collision in the event of a failure. The safety system can be designed in such a way that the maximum accelerations and decelerations of the test subjects, i.e. the test vehicles, are not exceeded.

In addition, a method is provided for the operation of a test stand for the validation of driver assistance systems of automated motor vehicles. The test stand contains a rail system with at least two guide rails crossing at an intersection point, a transport carriage for each guide rail for transporting a test vehicle, and a safety system with a priority circuit arranged at the intersection point. The method is characterized in that, by means of the priority circuit, it prevents the two transport carriages moving along the respective guide rail towards the intersection point from passing through the intersection point at the same time.

The test stand used in the method may be the test stand described above.

What has been described above with reference to the test stand, which can also be referred to as a motor vehicle test stand, also applies by analogy to the method and vice versa.

An embodiment is described below with reference to FIGS. 1 to 5.

### BRIEF DESCRIPTION OF THE DRAWINGS

FIG. 1 shows schematically a test stand for validating driver assistance systems of automated motor vehicles;

FIG. 2 shows schematically another test stand for validating driver assistance systems of automated motor vehicles;

FIG. 3 shows schematically a structure of the test stand from FIG. 1 in a top view;

FIG. 4 shows schematically the structure of the test stand from FIG. 1 in a perspective side view; and

FIG. 5 shows schematically a structure of a brake system of the test stand from FIGS. 1 and 2 in a top view.

### DETAILED DESCRIPTION OF THE DRAWINGS

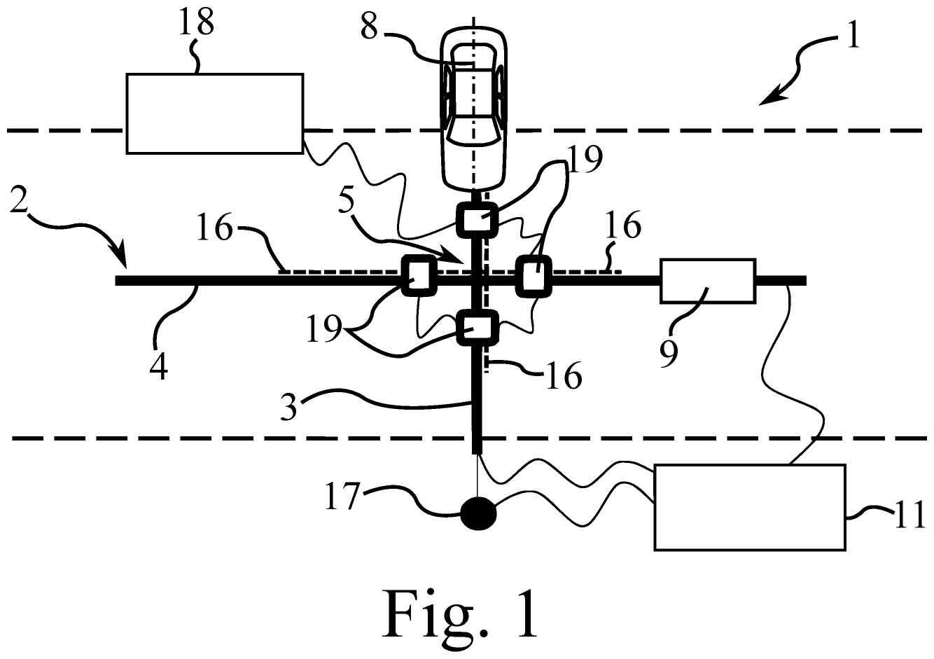

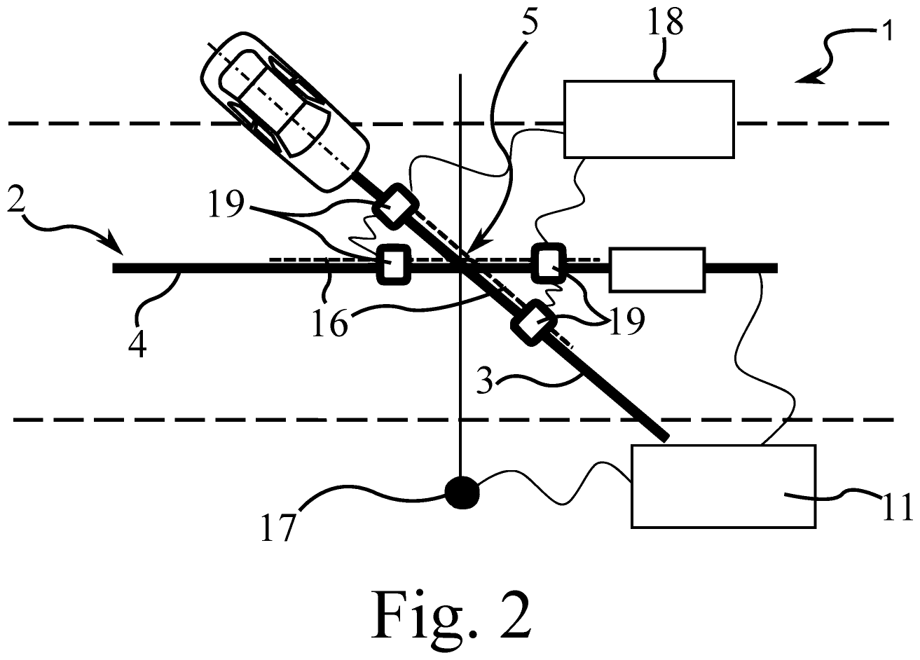

The test stand 1 shown in FIGS. 1 and 2 in a top view has a rail system 2 with two guide rails 3, 4, which cross at an intersection point 5. The two test stands 1 shown in FIGS. 1 and 2 differ only by an angle at which the two guide rails 3 and 4 run in relation to each other or at which the two guide rails 3 and 4 cross, wherein the angle is 90° in FIG. 1 and 45° in FIG. 2. These are just a few examples and really any other angle greater than 0° can theoretically be chosen.

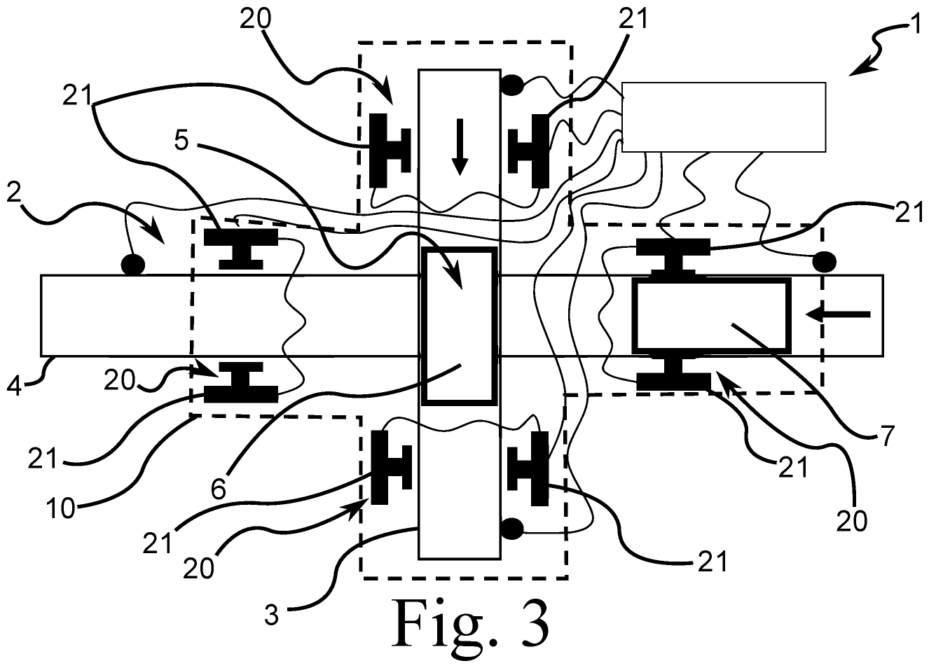

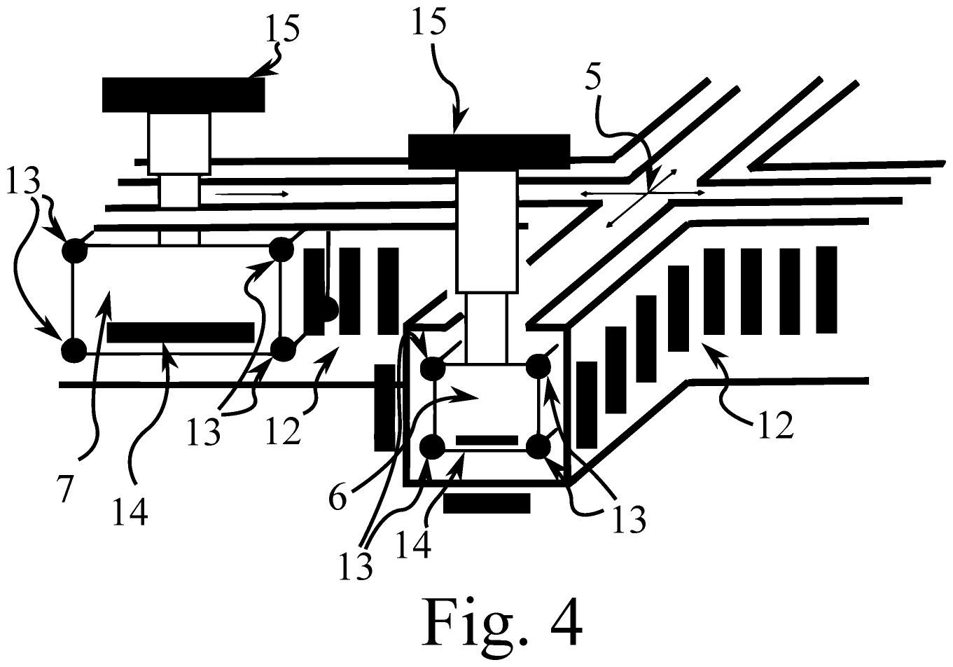

As can be seen in particular from FIGS. 3 to 5, each of the guide rails 3, 4 has a transport carriage 6, 7 guided both vertically and horizontally in the respective guide rail 3, 4, which has a vehicle holder 15 used to transport a test vehicle 8, 9.

The test stand 1 contains a linear motor 12 per guide rail 3, 4 for moving the respective transport carriages 6, 7 along the respective guide rail 3, 4 movably supported by means of rollers or plain bearings 13 in the respective guide rail 3, 4, wherein the linear motors 12 are connected to a control unit 11 for the rail system 2 and drive the respective transport carriages 6, 7 by means of a dynamo pick-up 14 arranged on or in the respective transport carriage 6, 7.

The test stand has a first position sensor system arranged along the guide rails 3, 4, which is designed to capture a respective current first actual position of the transport carriages 3, 4.

The first position sensor system has first position sensors 16 arranged along the respective transport rail/guide rail 3, 4 and a GPS reference point 17. The control unit 11 is designed to control a target position and target speed of the transport carriage 6, 7 by means of the respective linear motor 12 based on the first actual position of the respective transport carriages 6, 7 captured by the first position sensor system in such a way that the transport carriages 6,7 pass through the intersection point 5 without being at the intersection point 5 at the same time (i.e. without colliding).

In the present case, the two test vehicles 8, 9, i.e. more precisely a tested automated car 8 and a motorcycle 9, attached to the respective vehicle holder 15 are moving towards the intersection point 5, as illustrated in FIG. 3 by the arrows shown.

In addition, the test stand 1 has a safety system in an area 10 (see FIG. 3) around the intersection point 5 which is designed to prevent the two transport carriages 6 and 7 from passing through the intersection point 5 at the same time.

The safety system contains a control unit 18 for the priority circuit and a second position sensor system with light barriers 19 arranged in the area of the intersection point, which is designed to determine a second actual position of the transport carriages 6, 7, i.e. to determine, by means of the light barriers 19, whether the respective transport carriage 6, 7 is located in the area 10 around the intersection point 5.

The control unit 18 for the priority circuit and the control unit 11 for the rail system 2 are implemented as two physically separate systems.

The control unit 18 for the priority circuit is designed to control the priority circuit based on the second actual positions captured by the second position sensor system in such a way that the priority circuit prevents the simultaneous passage 5 of the transport carriages 6, 7 through the intersection point.

For this purpose, the control unit 18 for the priority circuit blocks the passage in the respective guide rail 3, 4, the respective transport carriage 6, 7 of which is not (yet) in the area 10 around the intersection point 5, by means of multiple (here four) brake systems 20. This means that the priority circuit contains two of the brake systems 20 for each guide rail 3, 4, wherein a first of the two brake systems 20 is arranged on one side of the intersection point 5 and a second of the two brake systems 20 on the opposite side of the intersection point 5, so that the respective guide rail 3, 4 can be operated in both directions. The blocking of the respective guide rail 3, 4 can either be carried out for a predetermined period of time after the entry of the first transport carriage 6, 7 into the area 10 around the intersection point 5 or can be carried out until the light barrier 19 on the side of the respective guide rail 3, 4 opposite the entry side of the first transport carriage 6, 7 determines that the first transport carriage has left the area 10 again, i.e. has passed the intersection point 5.

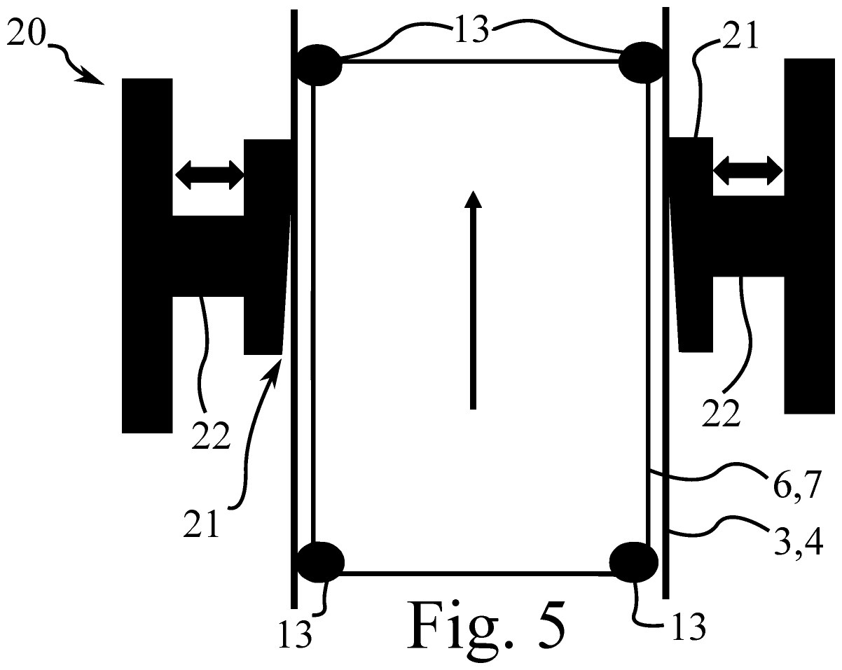

As can be seen in particular from FIG. 5, each of the brake systems 20 contains two brake shoes 21, which are wedge-shaped, i.e. the brake shoes 21 of the brake system 20 have a shape widening linearly towards the intersection point 5 (indicated by an arrow in FIG. 5 and corresponding to the direction of travel of the respective transport carriage 6, 7).

The two brake shoes 21 arranged opposite each other on the respective guide rail 3, 4 are controlled in the manner described above by the control unit 18 for the priority circuit by means of the brake actuators 22 for braking the respective transport carriage 6, 7 to a stop moving towards each other (see double arrows in FIG. 5, wherein in FIG. 5 the state of the unobstructed passage is shown). This means that in order to lock and release the respective guide rails 3, 4, the brake shoes 21 of the brake system 20 are moved towards or away from each other by means of the brake actuators 22 in order to achieve a width of the respective guide rail that can be traversed for the respective transport carriage 6, 7 3,4 and thus to safely prevent a collision of the transport carriages 6, 7 at the intersection point 5.

### REFERENCE SIGN LIST

1 Test stand
2 Rail system
3 Guide rail
4 Guide rail
5 Intersection point of the guide rails
6 Transport carriage
7 Transport carriage
8 Motor vehicle to be tested
9 Dummy vehicle or real vehicle used in the test
10 Area around the intersection point
11 Control unit for the rail system
12 Linear motor
13 Rollers and/or plain bearings
14 Dynamo pickup
15 Vehicle holder
16 First position sensors
17 GPS reference point
18 Control unit for priority circuit
19 Light boxes
20 Brake systems
21 Brake shoe
22 Brake actuators

1.-10. (canceled)

11. A test stand for protecting driver assistance systems of automated motor vehicles, comprising:
a rail system with at least two guide rails crossing at an intersection point;
two transport carriages, one for each guide rail, for transporting test vehicles; and
a safety system having a priority circuit located at the intersection point, wherein
the safety system is configured to prevent the two transport carriages from passing through the intersection point at the same time.

12. The test stand according to claim 11, wherein the rail system comprises:
a motor per guide rail for moving a respective transport carriage along a respective guide rail;
a first position sensor system arranged along the guide rails, which is configured to capture a current first actual position of the two transport carriages; and
a rail system control unit configured to control a target position and a target speed of a respective transport carriage via a respective motor based on the first actual positions captured by the first position sensor system such that the two transport carriages pass through the intersection point without being at the intersection point at the same time.

13. The test stand according to claim 11, wherein the safety system comprises:
a priority circuit control unit for the priority circuit; and
a second position sensor system arranged in the area of the intersection point, which is configured to determine a respective second actual position of the two transport carriages,
wherein the priority circuit control unit is configured to control the priority circuit based on the second actual positions captured by the second position sensor system such that the priority circuit prevents the two transport carriages from passing through the intersection point at the same time.

14. The test stand according to claim 13, wherein
the priority circuit control unit is further configured to control the priority circuit based on the second actual positions such that crossing the intersection point by a second of the two transport carriages is prevented for a predetermined period of time after the area of the intersection point is reached by the second of the two transport carriages.

15. The test stand according to claim 13, wherein
the rail system comprises:
a motor per guide rail for moving a respective transport carriage along a respective guide rail;
a first position sensor system arranged along the guide rails, which is configured to capture a current first actual position of the transport carriages; and
a rail system control unit configured to control a target position and a target speed of the respective transport carriage via a respective motor based on the first actual positions captured by the first position sensor system such that the transport carriages pass through the intersection point without being at the intersection point at the same time; and
wherein the priority control unit for the priority circuit and the rail system control unit for the rail system are implemented as two separate systems.

16. The test stand according to claim 11, wherein
the priority circuit in the area of the intersection point for each guide rail has at least one brake system in each case with two brake actuators with brake shoes arranged opposite each other on the respective guide rail for braking or stopping the respective transport carriage.

17. The test stand according to claim 16, wherein
the priority circuit for each guide rail has at least two such brake systems,
a first of the two brake systems is arranged on one side of the intersection point, and
a second of the two brake systems is arranged on an opposite side of the intersection point so that the respective guide rail can be operated in both directions.

18. The test stand according to claim 17, wherein
the brake shoes of the brake system are movable towards and/or away from each other via the brake actuators in order to decrease or increase a traversable width of the respective guide rail for the respective transport carriage.

19. The test stand according to claim 16, wherein
the brake shoes of the brake system have a shape that widens towards the intersection point.

20. The test stand according to claim 19, wherein
the widening of the brake shoes is a linear widening.

21. A method for operating a test stand for protecting driver assistance systems of automated motor vehicles, the method comprising:
providing a test stand having:
a rail system with at least two guide rails crossing at an intersection point,
two transport carriages, one for each guide rail, for transporting test vehicles, and
a safety system having a priority circuit arranged at the intersection point; and
preventing, via the priority circuit, the two transport carriages, which each move along a respective guide rail towards the intersection point, from passing through the intersection point at the same time.
